(19) United States
(12) Patent Application Publication
(10) Pub. No.: US 2015/0316971 A1
(43) Pub. Date: Nov. 5, 2015

(54) METHOD AND APPARATUS TO REDUCE POWER CONSUMPTION OF MOBILE AND PORTABLE DEVICES WITH NON-VOLATILE MEMORIES

(71) Applicant: Avalanche Technology, Inc., Fremont, CA (US)

(72) Inventors: Ravishankar TADEPALLI, Fremont, CA (US); NGON VAN LE, Fremont, CA (US)

(73) Assignee: Avalanche Technology, Inc., Fremont, CA (US)

(21) Appl. No.: 14/269,049

(22) Filed: May 2, 2014

(51) Int. Cl. G06F 1/32; G06F 9/44

(52) U.S. Cl. CPC G06F 1/3203; G06F 9/4418

(57) ABSTRACT

An unified power management scheme for all the idle subsystems during normal mode of operation and power save mode of operation reduces significant power and time during saving and restoring context of System on a chip (SoC). Power management schemes based on subset of manufacturing tests and high speed non-volatile memory provides transparency and shortest latency of entering and exiting power save mode and as a result providing significant power savings and extending battery life. Due to the shortest logic delays in some phases of logic scan, memory BIST and analog BIST, entry procedure and exit procedures from power save mode consume least amount of time with little overhead due to clock switching and power gating procedures. Any part of SoC that can be tested during manufacture using standard procedures of logic scan, memory BIST, analog BIST and boundary scan will be able to enter and exit power save mode and still retain the state. By enabling power to the functional units only while they are performing a function prolongs the duration of normal operation with a single charging of the battery for mobile and portable devices.

### BACKGROUND OF THE INVENTION

1. Field of the Invention

The invention relates generally to reducing power consumption in mobile and portable devices and more particularly to methods and apparatus for fast and unified saving and restoring the context of a devices, such as mobile application processor, mobile multi-media processor or mobile baseband processor connected to spin transfer torque magnetic random access memory (SSTMRAM).

2. Description of the Prior Art

System-on-chip (SoC) processors implement power management features by saving the context of the chip prior to the power down sequence into an external low-speed non-volatile memories or external volatile memories that are always powered. After the power up sequence, data is restored from the non-volatile memory into SoC memory. After the data is restored, CPU in SoC has to reprogram subsystems that were powered down to restore the state prior to power down sequence. This consumes significant amount of power after restoration and is dependent on the subsystem being restored. If any data accesses to remote node are pending, local node cannot enter into power down mode. Local node entering into power down mode introduces loss of bandwidth, increase in latency and increase in retransmissions of data due to slow entry and exit procedures.

In a typical operation of a mobile system, different subsystems are powered by individual voltage rails. This is required to power gate any idle subsystem independently of other active subsystems and reduce the leakage current. For a subsystem that is in idle state cannot restore its state after power up without the intervention of another active system. This also limits the subsystems to enter into powered down state when idle times are significantly higher than regular mode of operation. Another limitation is that idle subsystem should transition into a state benign to the restoration process. Intervention of active subsystem slows down the process of saving and restoring the state of the idle subsystem and drains the battery power. In a typical system, intervention schemes are based on register accesses and memory DMA accesses. Due to the additional overhead of saving and restoring data for idle subsystems is high and inability to restore to exact state before power down, subsystems resort to other power saving modes like clock gating or frequency scaling or lower voltage operation or use of retention flops instead of powering off or stay in normal mode of operation for relatively longer intervals of idle times and consume significant battery power.

### SUMMARY OF THE INVENTION

To overcome the limitations in the prior art described above, and to overcome other limitations that will become apparent upon reading and understanding the present specification, the present invention discloses different methods for saving and restoring context of a subsystem that is transparent to rest of the subsystems, provides a uniform approach for saving and restoring the state of the subsystem, reduces the overhead of active subsystems and a faster approach to save and restore the state of the subsystem.

Briefly, an embodiment and method of the present invention includes usage of some of the phases in a manufacturing test for logic scan, memory Built-in Self Test (BIST), analog Built-in Self Test (BIST) and boundary scan techniques for faster, unified save and restore of the state of the idle subsystems.

Several advantages of the various embodiments of the invention are evident to those skilled in the art after having read the following detailed description of the embodiments illustrated in the several figures of the drawing. The inventions described in the following figures can be extended to other non-volatile memories but not limited to—Magnetic Random Access Memory(—MRAM) with minimal overhead on the data management.

The requirement is a faster and unified scheme for saving and restoring the context of a subsystem with minimal intervention from the active subsystems and ability to enter and exit power save mode transparently to the remote node and even during shorter intervals of idle times.

### IN THE DRAWINGS

FIG. 1 shows a System on a Chip 100, in accordance with an embodiment of the present invention with integrated MRAM and Power Management controller unit.

FIG. 2 shows further details of the power management controller element 200, in accordance with an embodiment of the present invention.

FIG. 3 shows a flow chart element for saving state, in accordance with an embodiment of the present invention.

FIG. 4 shows a flow chart element for restoring state, in accordance with an embodiment of the present invention.

FIG. 5 shows a timing diagram element for fast & transparent save and restore, in accordance with an embodiment of the present invention.

FIG. 6 shows a system with multiple System on chips with external power management controller powered by auxillary power source and MRAM, in accordance with an embodiment of the present invention.

Table 1 shows an exemplary table for power configuration for saving and restoring the state of SoC.

Table 2 shows an exemplary table for power policy for saving and restoring the state of SoC.

### DETAILED DESCRIPTION OF VARIOUS EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

Although the invention has been described in terms of specific embodiments, it is anticipated that alterations and modifications thereof will no doubt become apparent to those more skilled in the art. It is therefore intended that the following claims be interpreted as covering all such alterations and modification as fall within the true spirit and scope of the invention.

In accordance with an embodiment and method of the invention, power consumption is reduced in mobile and portable devices by saving and restoring the exact state of the system in normal mode of operation and powering down even in relatively small durations of idle modes by using a subset of the manufacturing test procedures available to system-on-chip (SoC) processors and interfacing to high speed non-volatile memories such as (STTMRAM) or with embedded non-volatile memories such as STTMRAM. By enabling power to each of the subsystems when the subsystems are performing a desired function and high speed saving & restoring the state wherein each of the subsystem performs a function, a mobile platform with lowest power consumption and long battery life can be realized.

A System on Chip (SoC) element refers to one or more subsystems. Each of the subsystems comprises of digital logic implemented with scannable flip-flops, non-scannable retention flip-flops and combinatorial logic. In addition to digital logic, each of the subsystems may include one or more analog modules, one or more embedded memories either volatile or non-volatile in nature and may include ports interfacing to the external components.

In accordance with some embodiments of the invention, the state of each of the subsystem is preserved in scannable flip-flops, non-scannable retention flip-flops, non-scannable non-retention flip-flops, embedded memories, shift registers between analog and digital modules and shift registers between digital logic and interface ports.

In accordance with an embodiment of the invention, each of the subsystems in a System on Chip (SoC) performs a dedicated function. Some of the functions include but are not limited to baseband processing, application processing, multi-media processing, memory controller functions, display controller functions, user interface control element function, peripheral subsystem and mass storage subsystem function, and a whole slew of other functions too many to list. Each of the subsystems are in active state or idle state or different level of power state like clock-gated state or low-frequency state.

System-on-chip processors consists of multiple subsystems and each of the subsystems consists of digital logic, embedded memories and analog blocks. These individual blocks operate in various test modes to support manufacturing tests. These tests include logic scan, memory Built-In Self Test (BIST) and analog BIST. Scan mode consists of three phases. In a first phase, it shifts a known pattern to the digital logic. In the second phase, it allows the digital logic to compute. In the third phase, it shifts the computed data to external test equipment to check for faults. The first and third phases are high speed processes since they are only a shift operation. In memory BIST, a known pattern is loaded into the embedded memory in the first phase and read out in the second phase. Based on the data read in the second phase, faulty memory cells are identified.

In analog BIST, a known pattern is loaded into the interface memory in the first phase and values are read on the analog port or a suitable stimulus is applied to an analog port and data is read out from the interface memory. In boundary scan mode of manufacturing test, known to those in the art, a known pattern is loaded into the interface cells in the first phase and values are read on the interface port or a suitable stimulus is applied to an interface port and data is read out from the interface cells. In a typical SoC, a very high percentage of design is covered by the manufacturing tests.

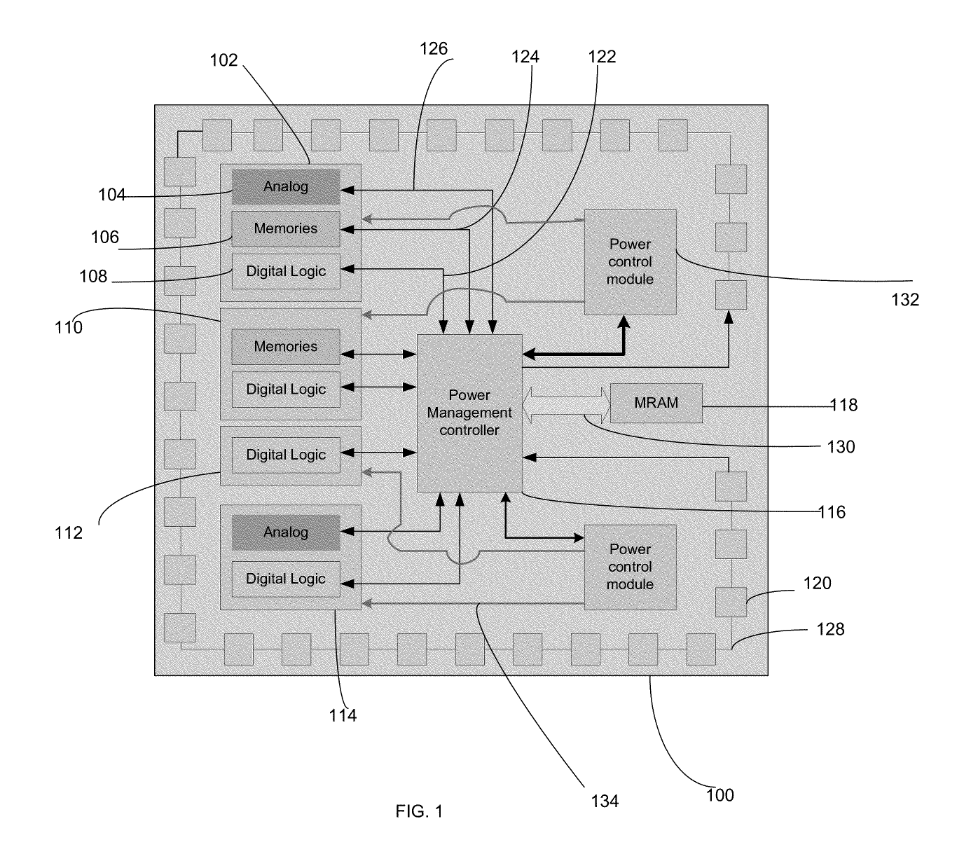

Referring now to FIG. 1, a system on chip (SoC) element 100 is shown, in accordance with an embodiment of the invention. Relevant components of the SoC element 100 are shown to comprise of a subsystem 102, subsystem 110, subsystem 112, subsystem 114, power management controller 116, non-volatile memory component 118 and boundary scan element 120 and power control module 132. Each of the subsystem 102, 110, 112, 114, 116 & 118 are individually powered by separate voltage rails and may have independent clocks.

In one embodiment shown in FIG. 1, subsystem 102 comprises of digital logic 108, embedded memories 106, which can be volatile or non-volatile like embedded MRAM, and analog module 104. Subsystem 110 comprises of embedded memories 106 and digital logic 108. Subsystem 112 only comprises of digital logic 108 and subsystem 114 comprises of analog block and digital logic. The SoC, element generally includes one or more of each of the subsystems 102, 110, 112 and 114. The number of subsystems, their functionality, design partitioning and hierarchy of subsystems are well known to those who are skilled in the art of SoC design and is therefore intended that the following claims be interpreted as covering all such alterations and modifications falling within the true spirit and scope of the invention.

Referring again now to FIG. 1, each of the subsystems 102, 110, 112 & 114 which are grouped as per their power domain are connected to power management controller 116. Power management controller 116 interfaces to each subsystem using logic scan interface element 122, memory BIST interface element 124 and analog BIST interface 126 and non-volatile memory component element 118 using a memory interface element 130. Interface ports are connected to the power management controller with shift register element 120 using the boundary scan connection. Each of the subsystems 102,110,112 & 114 receive power from the power control module(s) 132 on a separate rails 134. Power control module 132 implements a voltage regulator and a gating circuitry and receives inputs from the power management control module 116. Power management control module and interface blocks also receives power from one or more power control modules.

Now referring to FIG. 1 again, when power management unit receives triggers from idle timers to go into power down state, state of the each subsystem is read using shift out procedures of logic scan, reading embedded memory using MBIST and analog interface data using Analog BIST interfaces into embedded non-volatile memory. Since state of the subsystem is stored into non-volatile memory or volatile memory that is always powered, power for any of the subsystem 102,110,112,114 under consideration is shut-off by switching off the power regulator that is supplying power to the corresponding subsystem. By turning off the power, subsystem under consideration is not consuming any power including leakage power or dynamic power. This is lowest powerdown state for any subsystem with capability to restore state to pre-powered down state. This saves significant battery life.

In reference to FIG. 1 again, when power management unit receives triggers from activation timers for any subsystem that is powered down to exit from power save state. Exit from power save mode involves turning on the power regulator to supply power to the subsystem, enable shift clocks and reading state of subsystem from embedded non-volatile memory and shifting in data into subsystem using shift-in procedures of logic-scan interface, writing data into embedded memories using memory BIST interface and shifting in analog interface state on analog BIST interface. Since any subsystem is restored to its pre-powered down state without the involvement of CPU, it consumes less power independent of CPU state. If CPU or any other subsystem is required then it consumes power during the boot-up procedures, moving data from external non-volatile memory to system memory. By not involving CPU in restoration of state of the each subsystem, power consumption during exit from power save mode is reduced significantly and extending life of battery during normal mode of operation.

Now referring to Table 1, in the context of an embodiment of the current invention, each row from R2 to R5 represents the characteristics of each of the subsystem 102,110,112 and 114 with respect to saving and restoring their state. For example, row R2 indicates that for subsystem 102, there exists 4 scan chains with a maximum length of the 10,000 flops, 2 embedded memories of sizes 8 KB and 4 KB, an analog interface and an user defined address region that needs to be stored and restored into non-volatile memory like MRAM and the columns C8,C9,C10,C11 indicate the address region wherein state of subsystem 102 is stored before entering into power save mode and restored after exiting from power save mode. It is well known to those skilled in the art of SoC design that there are multiple ways of defining the configuration of a system and the current invention encompasses all such definitions.

Now referring to Table 2, in an embodiment of the current invention, each row from R2 to R5 represents the power policy for subsystems 102,110,112 and 114. It represents the information regarding the timing and inputs of entering into power save mode and exiting from power save mode. For example, Column C2 and row R2 represents that inputs to be used for subsystem 102 to enter into a power save mode and column C4 and Row R2 represents the inputs to be used for subsystem 102 to exit from power save mode. It is well known to those skilled in the art of SoC design that there are multiple ways of defining the policy of a system and the current invention encompasses all such definitions.

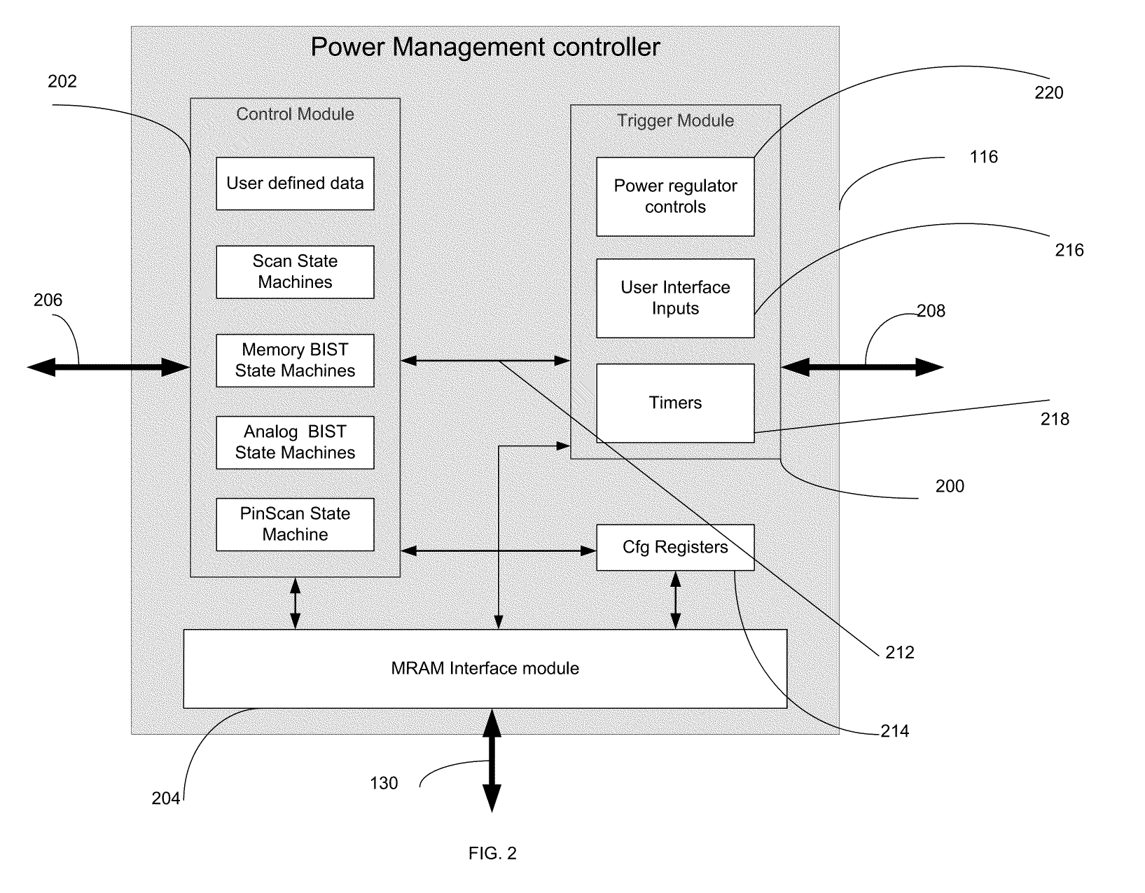

An exemplary embodiment of power management controller 116 is indicated in FIG. 2. Power management controller 116 comprises of control module 202, trigger module 200, configuration and status registers 214 and MRAM interface module 204. Power management controller interfaces to MRAM interface module 204 through interface 130, and interfaces to the remaining subsystems of the SoC 100 using the interface 206. Interface 206 is a combination of logic scan, memory BIST, analog BIST and boundary scan signals. Configuration registers module 214 stores the information regarding the power groups and power management policies and nature of embedded memories and their requirements to store and restore data during entry and exit of power save mode. Some of the information without limitation is the existence of analog module or embedded memories and their memory maps, bypass the saving and restoring of data from each of the subsystem indicating entry and exit policies. Entry and exit policies into a power save mode for each of the subsystems that are individually powered can also be saved into configuration registers 214 by implementing register mask bits that enable or disable user interface inputs 216 or timer inputs 218 in the trigger module 200.

In reference to FIG. 2, trigger module 200 implements power regulator control element 220, user interface control elements 216 and timer elements 218 corresponding to each of the subsystems that are individually powered. Power regulator control module 220 generates signals that enable or disable power to each of the subsystems. User interface element 216 samples user inputs like keyboard or touch screen that trigger use of a particular application on the mobile platform. Timer elements 218 implements generation of periodic signals. Some of the functions of timer elements include but not limited to are idle timers which indicate the duration of time a subsystem is in idle state, wireless beacon generation timer and any other such functionality.

In reference to FIG. 2, control module 202 implements control logic to store and restore state information for each subsystem using various procedures like logic scan, analog BIST, memory BIST, pinscan, and reading & writing of registers implemented in each subsystem.

Power management controller 116 as indicated in an embodiment in FIG. 2 controls the power state of the each of the subsystems, sequences saving and restoring of state information as per the power management policies and capabilities of each of the subsystems 102, 110, 112 and 114. By enabling power to each of the subsystems 102, 110, 112 and 114 only when they are performing an intended function and high speed saving and restoring the state wherein each of the subsystem 102, 110, 112 & 114 performs a function, a mobile platform with lowest power consumption and long battery life can be realized.

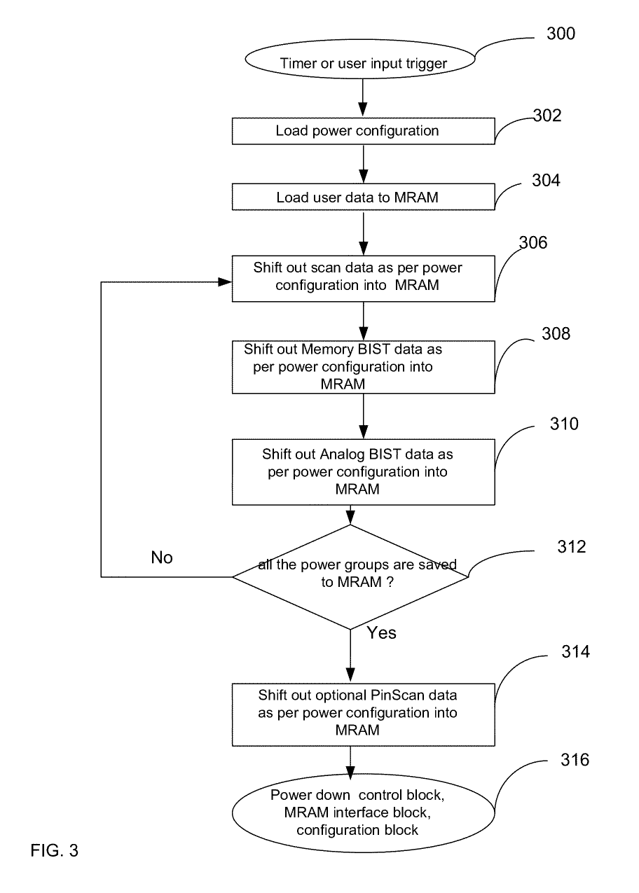

In reference to FIG. 3, relevant steps of the process for starting the power save mode are shown, in accordance with a method of the invention. Entry into power save mode is triggered either by an idle timer expiration or a control signal or based on a user input signal or based on preset parameters in configuration registers or based on the a signal that indicates the availability of data to be processed. This power configuration is loaded into the MRAM interface module 204 or any other non-volatile memory so that it can be used during restoration procedures. In some of the applications, the state of an entire subsystem need not be required to be saved rather only a subset of registers are saved. This information is stored in the user data segment of control module 202 of the power management controller 116. As part of the power policy, only user data can be saved in the MRAM interface module 204 and other steps can be bypassed. As per the power configuration, for each of the subsystems 102,110,112 and 114, state of the digital logic element 108 is scan shifted on logic scan interface 122 and MRAM interface element 204 and loaded into MRAM 118 on the interface 130. interface module 204. As per the power configuration, for each of the subsystems 102 and 110, embedded memory data of the memory element 106 is shifted on memory BIST interface 124 and MRAM interface module 204 and loaded into MRAM 118 on the interface 130. As per the power configuration, for each of the subsystem 102 and 114. state of Analog interface data is shifted on Analog BIST interface 126 and MRAM interface module 204 into MRAM element 118 on interface 130. When all the data from each of the subsystems is saved to MRAM interface module 204, optionally boundary scan data 128 which represents the state of each of the interface cells 120 is shifted using pinscan interface 128 and MRAM interface element 204 and loaded into MRAM 118 on the interface 130. Once the state of the subsystems 102,110,112 and 114 are saved into MRAM element 118, control module 202 and MRAM interface module 204 of the power management controller 116 can be powered down by sending responses to power control module 132.

In reference to FIG. 3, Table 1 and Table 2, in an embodiment of the current invention, Step 300 and step 302 are executed in accordance to the fields in C2-C3 of Table 2 for all the rows. In step 304, information in column C7 of Table 1 is used in conjunction with column C11 to store user defined data into an MRAM for all the rows in the table 1. In Step 306, information in column C2, C3 of Table 1 is used in conjunction with C8 of Table 1 to store state of the digital logic into non-volatile memory like MRAM for any of the subsystems 102,110,112 and 114. In Step 308, information in column C4, C5 of Table 1 is used in conjunction with C9 of Table 1 to store state of the embedded memories into non-volatile memory like MRAM for any of the subsystems 102 and 110. In Step 310, information in column C8 of Table 1 is used in conjunction with C10 of Table 1 to store state of the analog interface registers into non-volatile memory like MRAM for any the subsystems 102 and 114. Steps 306,308, 310 are executed for all the rows in Table-1. In Step 312, it is checked if all the states of all the subsystems 102,110,112 and 114 are saved into MRAM. If all the steps rows in the Table 1 are completed, in step 314, information regarding the external interface pins is saved into non-volatile memory like MRAM. Since all the states of all the Subsystems has been saved into non-volatile memory, in step 316 corresponding subsystems are powered down by generating control signals to power regulator and also optionally power down some of the components like control unit 202, MRAM interface unit 204 and configuration registers 214 in the power management controller. It is well known to those skilled in the art of SoC design, the order of execution of each of the steps in FIG. 3 depends on the configuration of SoC and the optimizations in power management controller. All such variations and optimizations can be considered to be encompassed as part of the various embodiments of the invention.

In reference to FIG. 3, in one embodiment of the present invention for entry into power save mode is indicated. Entry into power save is triggered by various ways. Some of them include but not limited to is an idle timer expiration or a control signal or based on a user input signal or based on preset parameters in configuration registers or based on non-availability of connection to access point or no packet transmission and reception or loss of beacons from the remote node in step 300. The power configuration indicated in Table 1, is loaded from MRAM 118 or any other non-volatile memory into internal cfg registers 214 indicated in FIG. 2 in step 302. In Step 304, as per the power configuration indicated in Table 1 and power policies indicated in Table 2, data from internal registers for any of the subsystems 102,110,112 and 114 is saved into MRAM 118. As per the power configuration indicated in Table 1 and power policies indicated in Table 2 and existence of digital logic 108, scan data for each of the subsystems 102, 110, 112 and 114 is saved to MRAM 118 on logic scan interface 122 in step 306. In step 308, embedded memory 106 for each of the subsystems 102 and 110 is saved to MRAM 118 on Memory BIST interface 124. In step 310, for each of the subsystems 104 and 114, analog interface data is saved to MRAM 118 on Analog BIST interface 126. In Step 312, it is checked if all the rows R2, R3, R4 and R5 in power configuration Table 1, steps 306,308 and 310 have been executed. If execution of step 312 is positive, optionally boundary scan data for each of the interface cells 120 is saved to MRAM 118 on the interface 128 in step 314. If execution of step 312 is negative, then steps 306, 308 and 310 are executed for the corresponding row in power configuration Table-1. Once all the power groups as indicated in Table 1 are saved to MRAM 118, SoC 100 will be in power down mode till a next trigger to exit from power save mode is received to the power management controller 116.

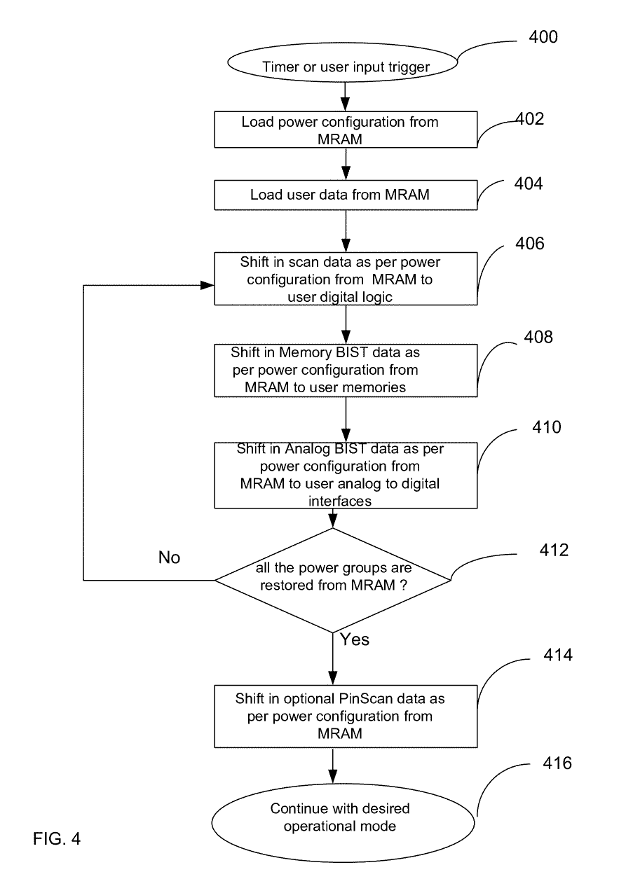

In reference to FIG. 4, in one embodiment of the present invention for exit from power save mode is indicated. Exit from power save is triggered by various ways. Some of them include but not limited to is a timer expiration or a control signal or based on a user input signal or based on preset parameters in configuration registers or based on packet reception from the remote node. The power configuration indicated in Table 1, is loaded from MRAM 118 or any other non-volatile memory into internal cfg registers 214 indicated in FIG. 2. If there was a user data saved into MRAM 118, this data will be restored into the internal data registers of one or more subsystem 102, 110, 112 and 114. As per the power configuration indicated in Table 1 power policies indicated in Table 2 and existence of digital logic 108, embedded memories 106 and analog modules 104, for each of the subsystems 102, 110, 112 and 114 scan data from MRAM 118 is loaded into each subsystem on logic scan interface 122 in step 406, embedded memory data from MRAM 118 into each of the subsystems 102 and 110 is loaded on Memory BIST interface 124 in step 408, analog interface data from MRAM into each subsystem 102 and 114 on Analog BIST interface 126 in step 410. In Step 412, it is checked if all the rows R2, R3, R4 and R5 in power configuration Table 1, steps 406,408 and 410 have been executed. If execution of step 412 is positive, optionally boundary scan data from MRAM 118 is loaded into each of the interface cells 120 on the interface 128 in step 414. If execution of step 412 is negative, then steps 406, 408 and 410 are executed for the corresponding row in power configuration Table-1. Once all the power groups as indicated in Table 1 are restored from MRAM 118, SoC 100 will be in normal operating mode till next power save mode is triggered.

In reference to FIGS. 3 and 4, although steps indicated were for entry into power save mode and exit from power save mode for SoC 100, it can be extended to configurations wherein power management control 116 and MRAM 118 are implemented separately for each of the subsystem 102, 110, 112 and 114 or for a group of subsystems in a SoC 100.

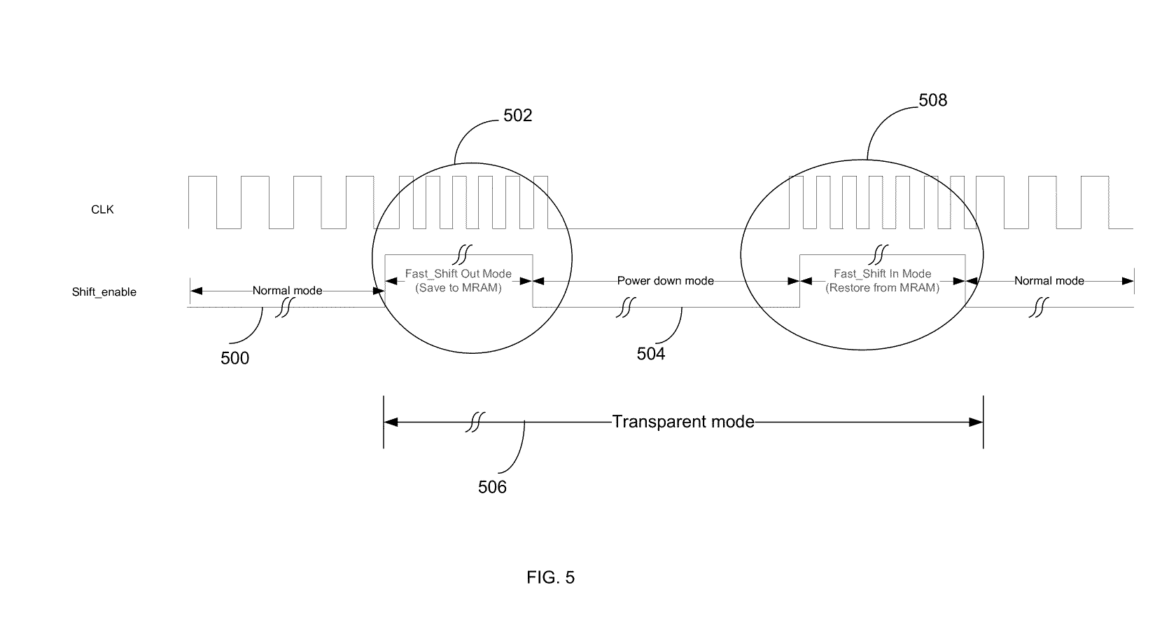

In reference to FIG. 5, one embodiment of the present invention for timing diagram for entry into power save mode and exit from power save mode is indicated. During normal mode of operation, a subsystem that is dependent on responses from remote node or based on timer inputs can enter into power save mode by saving data into non-volatile memory and exit from power save by restoring the data from non-volatile memory. Logic delays for scan shift is least in a digital logic and hence a faster clock can be used for saving the state of any subsystem or restoring the state of the subsystem. Using a faster clock reduces the time for entry and exit from power save mode. Each subsystem can go more often into power save mode and hence reducing the power consumption during normal mode of operation. Local node's power state transitions are transparent to remote node and is perceived as a node that is in normal mode of operation. It is apparent to those skilled in the art of SoC design the advantages and modes of such operations and the amount of power consumed in each mode of operation.

In reference to FIG. 5 again, State 500 represents the normal mode of operation, state 502 represents the fast mode of saving the state of one or more subsystems 102, 110, 112 and 114 into non-volatile memory like MRAM, state 504 represents the powered down mode and the lowest power state of any subsystem and consuming neither dynamic power nor the leakage power, state 508 represents fast exit from power save mode for one or more subsystems 102, 110, 112 and 114. In reference to an embodiment of the current invention, state 506 represents a transparent state of the SoC 100 to the remote node. A remote node in communication with one or more subsystems 102, 110, 112 & 114 is agnostic to the power state of the SoC 100. In intervals between the communications, subsystems 102, 110, 112 and 114 may be entering into the power down state and exiting from power down state and presenting active state to the remote node when communication is required without intervention of any active subsystem like a CPU. This scheme saves significant amount of power extending battery life significantly in a mobile system.

Now referring to FIG. 2 again, it is well known to those skilled in the art of SoC design that power management controller 116 can be implemented using very small number of logic gates. In the true spirit of the current invention, variations such as individually optimized power management controller 116 per any of the subsystem 102,110,112 and 114 and interfacing to local non-volatile memory and implementing separate power configuration similar to Table 1 and power policy Table 2 or for per group of subsystems 102, 110, 112 and 114 or implementation of a hierarchy of power management controllers 116 similar to hierarchy of subsystems in a SoC are encompassed to be part of the current invention.

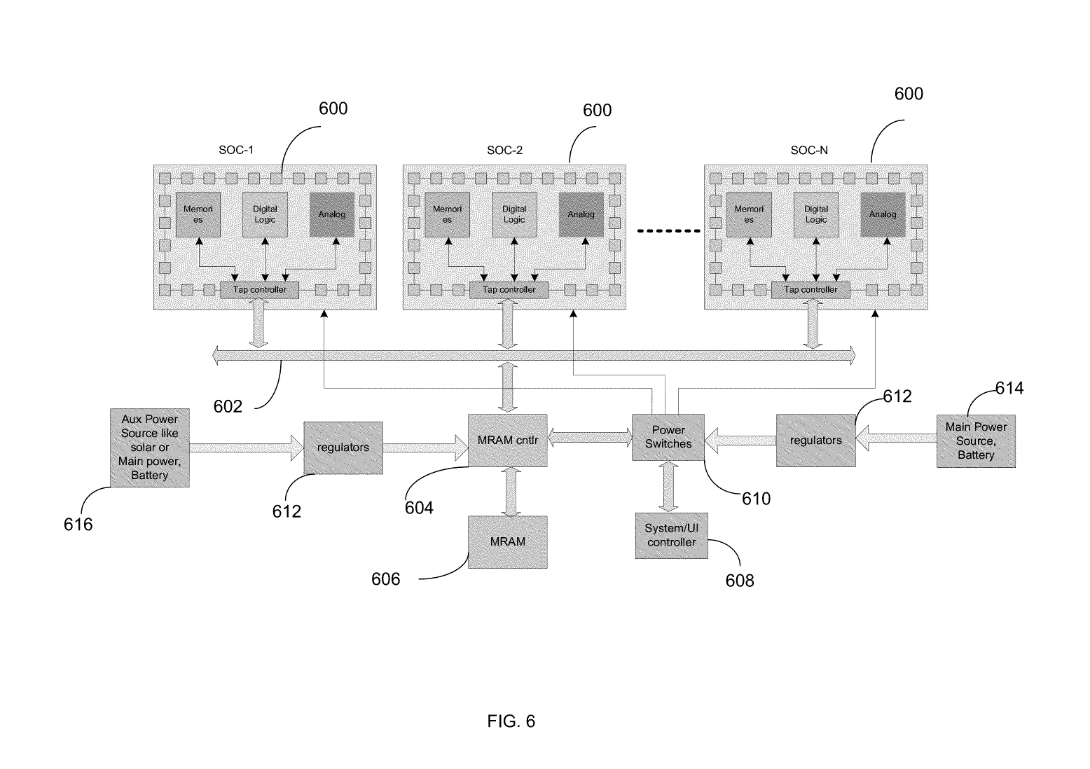

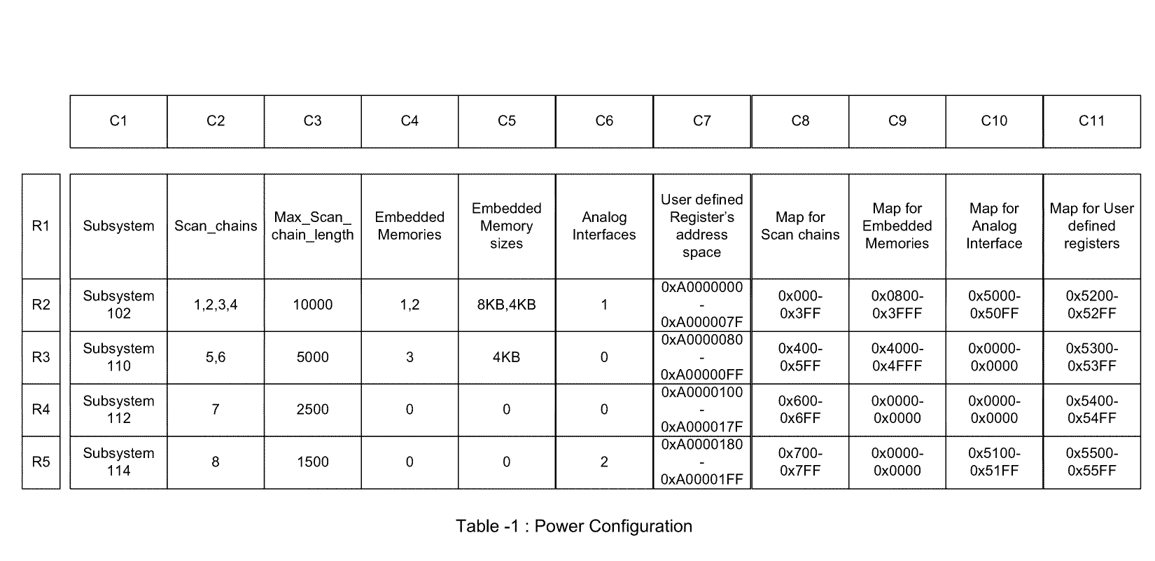

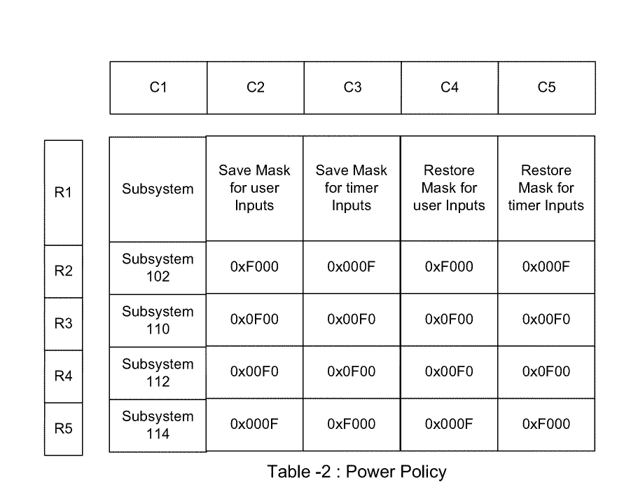

Now referring to FIG. 6, an embodiment for power management using test access ports can be extended for system applications with multiple SoCs. Each of the SoCs 600 implement a test access port controller. This is apparent to those skilled in the art of manufacturing tests using test access ports. Test access port allows access to internal logic-scan state machines, memory BIST state machines, analog BIST state machines and boundary scan logic. External Non-volatile memory controller with power management features 604 interfaces to non-volatile memory 606, power switches 610, system or user interface controller 608 and power sources 614 and 616 and regulators 612. Since power management controller has to be active to respond to external inputs, it can be powered by an auxiliary power source like solar energy and relieve the main power source. External non-volatile memory can be but not limited to any of the NAND, NOR, RRAM, PCM, FeRAM, EEPROM and MRAM etc. In the true spirit of the current invention, a high speed volatile memory like but not limited to DDR3, DDR4, LPDDR3 with power available at all times and can be in self-refresh mode can also be considered as non-volatile memory.

External memory controller 604 with power management features implements different power management policies of saving and restoring SoC's state to external non-volatile memory. Power groups and power management policies are triggered by timers, user interface inputs and control signals from each of the SoC. Memory mapping and memory requirements for logic scan, memory BIST, analog BIST and boundary scan for each of the SoCs can be preconfigured based on the system application.

Although the present invention has been described in terms of specific embodiment, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1. A power management scheme in a system on a chip (SoC) comprising:
a power management controller based on subset of manufacturing test procedures and a non-volatile memory.

2. A power management scheme in a system on a chip (SoC) preserving the state of SoC before entry into power save mode and after exiting from power save mode.

3. A power management scheme in a system on a chip (SoC) comprising:
a power management controller based on subset of manufacturing test procedures and a volatile memory which is powered by its own voltage rails.

4. The power management controller of claim 1 further incorporating faster save and restore procedures for idle subsystems with reduced overhead on active subsystems.

5. The power management controller of claim 1 further incorporating transparency of save and restore procedures for idle subsystems during normal mode of operation.

6. The power management controller of claim 1 further incorporating unified interface for save and restore procedures for idle subsystems during normal mode of operation and power save modes.

7. The power management controller of claim 1 further incorporating multiple power management groups for save and restore procedures for idle subsystems during normal mode of operation and power save modes.

8. The power management controller of claim 1 further incorporating multiple power management policies for save and restore procedures for idle subsystems during normal mode of operation and power save modes.

9. The power management controller of claim 1 further incorporating interfacing to multiple SoCs, external non-volatile memory, external power regulators and auxillary power source like solar and user interface modules.
